(19) United States
(12) Patent Application Publication
(10) Pub. No.: US 2017/0086280 A1
(43) Pub. Date: Mar. 23, 2017

(54) LIGHTING DEVICE WITH BI-DIRECTIONAL LIGHTING CONTROL AND ASSOCIATED METHODS

(71) Applicant: Lighting Science Group Corporation, Cocoa Beach, FL (US)

(72) Inventors: Mark Penley Boomgaarden, Satellite Beach, FL (US); Ryan Kelley, Denver, CO (US); Richard LeClair, Indian Harbour Beach, FL (US)

(73) Assignee: Lighting Science Group Corporation, Cocoa Beach, FL (US)

(21) Appl. No.: 15/371,282

(22) Filed: Dec. 7, 2016

Related U.S. Application Data
(63) Continuation-in-part of application No. 13/739,054, filed on Jan. 11, 2013.
(60) Provisional application No. 61/642,205, filed on May 3, 2012.

(51) Int. Cl. H05B 37/02; F21K 9/232; F21K 9/238; F21V 3/02; F21K 9/237; H05B 33/08; F21V 23/00; F21V 29/77; F21K 9/235

(52) U.S. Cl. CPC H05B 37/0227; H05B 37/0272; F21V 29/77; F21K 9/232; F21K 9/238; F21K 9/235; F21K 9/237; H05B 33/0854; H05B 37/0236; F21V 23/003; F21V 3/02; F21Y 2115/10

(57) ABSTRACT

A luminaire for directional emission of light comprising an optic defining an optical chamber, a first plurality of light elements positioned to emit light in a first direction, defined as an upward direction, a second plurality of light elements positioned to emit light in a second direction, defined as a downward direction, and a driver circuit operably coupled to each of the first and second pluralities of light elements. The driver circuit is adapted to receive an input and is configured to operate the first and second pluralities of light elements so as to cause the luminaire to emit light in a downward distribution responsive to the input having a first configuration. Additionally, the driver circuit is configured to operate the first and second pluralities of light elements so as to cause the luminaire to emit light in an omnidirectional distribution responsive to the input having a second configuration.

### RELATED APPLICATIONS

This application is a continuation-in-part of and claims the benefit under 35 U.S.C. §120 of, U.S. patent application Ser. No. 13/739,054 titled Luminaire with Prismatic Optic filed Jan. 11, 2013 (Attorney Docket No. 221.00126), which, in turn, claims the benefit under 35 U.S.C. §119(e) of U.S. Provisional Patent Application Ser. No. 61/642,205 titled Luminaire with Prismatic Optic filed May 3, 2012 (Attorney Docket No. 221.00068), the contents of each of which are incorporated in their entireties herein by reference except to the extent that the contents therein conflict with the content herein.

### FIELD OF THE INVENTION

The present invention relates to systems and methods for a lighting device with directional lighting control.

### BACKGROUND OF THE INVENTION

Most of the earliest light bulbs were incandescent, which generate light by heating a filament wire until it glows. Due to the relatively sparse nature of the supporting structures necessary for the filament, and due to the 360-degree dispersion of light by the filament, incandescent light bulbs provide a nearly uniform distribution of light.

Fluorescent lamps, specifically compact fluorescent lamps (CFLs), have been steadily replacing incandescent light bulbs in many lighting applications. Similar to incandescent lamps, CFLs produce light in approximately 360 degrees by exciting mercury vapor to cause a gas discharge of light. CFLs are more energy efficient than incandescent light bulbs, but suffer a number of undesirable traits. Many CFLs have poor color temperature, resulting in a less aesthetically pleasing light. Some CFLs have prolonged warm-up times, requiring up to three minutes before maximum light output is achieved. All CFLs contain mercury, a toxic substance that must be handled carefully and disposed in a particular manner. Furthermore, CFLs suffer from a reduced life span when turned on and off for short periods of time. Therefore, there are a number of disadvantages to using CFLs in a lighting system. Furthermore, due to the space requirements for tubing components of CFLs, accomplishing directional output often requires more space, preventing such directional CFLs from complying with industry standard sizing.

Light emitting diodes (LEDs) are increasingly being used as the light source in light bulbs. LEDs offer greater efficiencies than CFLs, have an increased life span, and are increasingly being designed to have desirable color temperatures. Moreover, LEDs do not contain mercury or any other toxic substance. However, by the very nature of their design and operation, LEDs have a directional output. Accordingly, the light emitted by an LED may not have the nearly omni-directional and uniform light distribution of incandescents and CFLs. Although multiple LEDs can and frequently are used in a single light bulb, solutions presented so far do not have light distribution properties approximating or equaling the dispersion properties of incandescents or CFLs.

One issue facing the use of LEDs to replace traditional light bulbs is heat. LEDs suffer damage and decreased performance when operating in high-heat environments. Moreover, when operating in a confined environment, the heat generated by the LED and its attending circuitry itself can cause damage to the LED. Heat sinks are well known in the art and have been effectively used to provide cooling capacity. This assists with maintaining an LED-based light bulb within a desirable operating temperature. However, heat sinks can sometimes negatively impact the light distribution properties of the light bulb resulting in non-uniform distribution of light from the bulb.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

In view of the foregoing, it is an object of the present invention to provide a luminaire having a light distribution which is variable based on input from a user, utilizes a particularized structure and method for direction control, and is energy efficient. These and other objects, features and advantages according to embodiments of the present invention are provided by a luminaire A luminaire for directional emission of light comprising an optic defining an optical chamber; a first plurality of light elements positioned so as to emit light in a first direction, defined as an upward direction, a second plurality of light elements positioned so as to emit light in a second direction, defined as a downward direction, and a driver circuit operably coupled to each of the first and second pluralities of light elements. The driver circuit is adapted to receive an input and is configured to operate the first and second pluralities of light elements so as to cause the luminaire to emit light in a downward distribution responsive to the input having a first configuration. Additionally, the driver circuit is configured to operate the first and second pluralities of light elements so as to cause the luminaire to emit light in an omnidirectional distribution responsive to the input having a second configuration.

In some embodiments, the driver circuit may be configured to operate only the second plurality of light elements responsive to the input having the first configuration. Alternatively, the driver circuit may be configured to operate the second plurality of light elements at a maximum intensity and the first plurality of light elements at a reduced intensity responsive to the input having a first configuration. Further, the driver circuit may be configured to operate both the first and second pluralities of light elements at a maximum intensity responsive to the input having the second configuration. The driver circuit may also be configured to operate each of the first and second pluralities of light elements at a reduced intensity using pulse width modulation.

In other embodiments, the driver circuit may be configured to operate at least one of the first and second pluralities of light elements to cause the luminaire to emit light in an upward distribution responsive to an input having a third configuration. In such a case, the driver circuit may be configured to operate only the first plurality of light elements responsive to the input having a third configuration. Alternatively, the driver circuit may be configured to operate the first plurality of light elements at a maximum intensity and the second plurality of light elements at a reduced intensity responsive to the input having a third configuration. Further, the luminaire may include a sensor positioned in electrical communication with the driver circuit and configured to determine a reflectance of light emitted by the luminaire. The sensor may be configured to generate a signal indicating the presence of an external structure within a proximity of either of a lower hemisphere or an upper hemisphere of the luminaire. The signal may be generated by the sensor being the input.

The luminaire may also include a wireless communication device positioned in electrical communication with the driver circuit. The wireless communication device may be configured to receive the input, which may be defined as a received input. The wireless communication device may also be configured to transmit the received input to the driver circuit. The wireless communication device may be selected from the radio communication devices, visible light communication devices, acoustic communication devices, and/or IR communication devices.

The luminaire may also include a user input device positioned in electrical communication with the driver circuit. The user input device may generate the input received by the driver circuit. The user input device may be operable to generate the first and/or second configurations of the input.

The luminaire may still further include a modal input positioned in electrical communication with the driver circuit and configured to generate a modal input signal comprising one of an enabling signal or a disabling signal. The driver circuit may be configured to operate the first and second pluralities of light elements so as to cause the light to be emitted in a downward distribution responsive to the input having the first configuration and the modal input having the enabling signal. Further, the driver circuit may be configured to operate the first and second pluralities of light elements so as to cause light to be emitted in a omnidirectional distribution responsive to the input having the first configuration and the modal input having the disabling signal. The modal input may be a switch positioned so as to be manipulable by a user.

The luminaire may still further include a light source board having an upper surface and a lower surface. The first plurality of light elements may be positioned on the upper surface of the light source board, and the second plurality of light elements may be positioned on the lower surface of the light source board. Either or both of the first and second pluralities of light elements may include LEDs. The luminaire may also include a sensor positioned in electrical communication with the driver circuit and configured to determine a reflectance of light. The sensor may be configured to generate a signal indicating a presence of an external structure within a proximity of the luminaire. The driver circuit may be configured to operate the first and second pluralities of light elements responsive to the signal generated by the sensor. More specifically, the driver circuit may be configured to emit light in an alternating succession of generally downward and generally uniform distributions responsive to each signal indicating the presence of an external structure within the proximity of the luminaire generated by the sensor. Further, the driver circuit may be configured to alter the distribution from downward to uniform, or vice versa, upon receiving such a signal indicating the presence of an external structure. As indicated above, either or both of the first and second pluralities of light elements may be provided by an LED, and the sensor may be an LED.

The above aspects of embodiments of the present invention may provide a luminaire capable of providing directional lighting control.

### BRIEF DESCRIPTION OF THE DRAWINGS

FIG. 1 is a side perspective view of a luminaire according to an embodiment of the present invention.

FIG. 2 is a perspective view of a lower structure of the luminaire illustrated in FIG. 1.

FIG. 3 is an exploded perspective view of a prismatic optic of the luminaire illustrated in FIG. 1.

FIG. 4a is a partial top plan view of the luminaire illustrated in FIG. 1.

FIG. 4b is a partial bottom view of the luminaire illustrated in FIG. 1.

FIG. 5 is a partial side sectional view of the prismatic optic of the illustration presented in FIG. 1 taken through line 5-5 of FIG. 1.

FIG. 6 is a perspective view of an upper structure of the luminaire illustrated in FIG. 1.

FIG. 7 is a sectional view of the upper section presented in FIG. 6 taken through line 7-7 in FIG. 6.

FIG. 8 is a perspective view of a light source used in connection with the luminaire illustrated in FIG. 1.

FIG. 9a is a perspective view of a housing used in connection with the luminaire illustrated in FIG. 1

FIG. 9b is a sectional view of the luminaire illustrated in FIG. 1 taken through line 9b-9b in FIG. 1.

FIG. 10 is a perspective view of a cap used in connection with the luminaire illustrated in FIG. 1.

FIG. 11 is a perspective view of the cross section view of the luminaire as illustrated in FIG. 9b.

FIG. 12 is a polar graphical illustration representing a light distribution of the luminaire illustrated in FIG. 1.

FIG. 13 is a side elevation of a luminaire according to an alternative embodiment of the invention.

FIG. 14 is a flow chart illustrating an exemplary method for controlling the luminaire according to the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

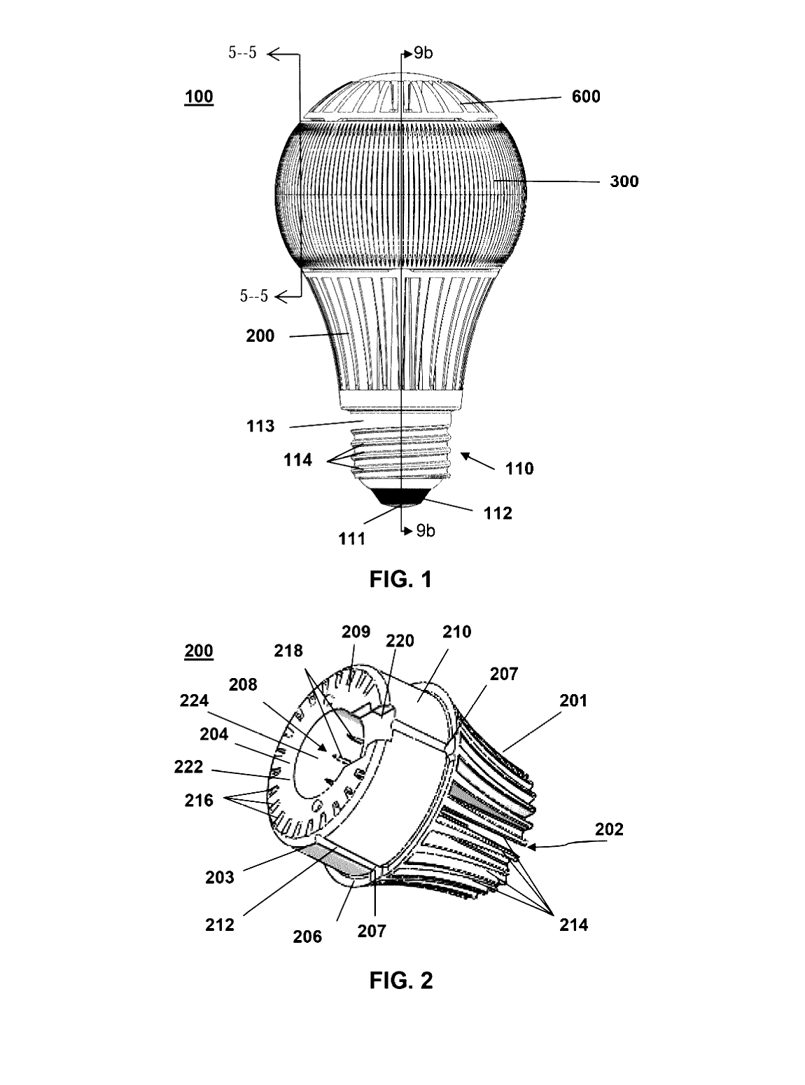

An exemplary embodiment of the invention, as shown and described by the various figures and accompanying text, provides a luminaire 100. Referring initially to FIG. 1, a luminaire 100 according to an embodiment of the present invention is depicted, the luminaire 100 including a base 110, a lower structure 200, a prismatic optic 300, and an upper structure 600.

The base 110 of an exemplary embodiment of the luminaire 100 is configured to conform to an Edison screw fitting that is well known in the art. However, the base 110 may be configured to conform with any fitting for light bulbs known in the art, including, but not limited to, bayonet, bi-post, bi-pin, wedge fittings, and any other customized or non-traditional fittings. Additionally, the base 110 may be configured to conform to the various sizes and configurations of the aforementioned fittings.

In an embodiment, the base 110 of the luminaire 100 may include an electrical contact 111 formed of an electrically conductive material, an insulator 112, and a sidewall 113 comprising a plurality of threads 114. The plurality of threads 114 may form a threaded fitting on inside and outside surfaces of the sidewall 113. The electrical contact 111 may be configured to conduct electricity from a light socket.

Turning to FIG. 2, the lower structure 200 may have a lower section 201 defining a first end 202 and an upper section 203 defining a second end 204. The interface between the lower section 201 and the upper section 203 may define a shelf 206 disposed about a perimeter of the lower section 201. The shelf 206 may include one or more attachment sections 207 to which the prismatic optic 300 may attach to the lower structure 200. The first end 202 may be attached to the base 110 at the sidewall 113 by any means known in the art, including, not by limitation, use of adhesives or glues, welding, and fasteners.

Each of the first section 201 and the upper section 203 may include a void that cooperates with each other to define a longitudinal cavity 208. The shape and dimensions of the longitudinal cavity 208 will be discussed in greater detail hereinbelow. The upper section 203 may include a body member 209 having an outside surface 210. The outer surface 210 may be positioned along a longitudinal axis of the luminaire 100. The outer surface 210 may be configured to reflect light incident thereupon. The outer surface 210 may have a reflection coefficient of at least about 0.1, or about 0.2, 0.3, 0.4, 0.5, 0.6, 0.7, 0.8, or 0.9, or about 0.91, 0.92, 0.93, 0.94, 0.95, 0.96, 0.97, 0.98, or 0.99, or about 1. In one embodiment, the outer surface 210 may act as a substrate and have a layer of reflective paint applied thereto. The reflective paint may advantageously enhance illumination provided by the light source by causing enhanced reflection of the light prior to reaching the prismatic enclosure 300. In another embodiment, the outer surface 210 may have a reflective liner applied thereto. Similarly, the reflective liner may be readily provided by any type of reflective liner which may be known in the art.

The upper section 203 may further include one or more channels 212 formed in the outer surface 210. The channels 212 may be configured to align with the attachment sections 207 and run parallel to the longitudinal cavity 208, facilitating the attachment of the prismatic optic 300 to the lower structure 200.

In an embodiment, the lower structure 200 may be configured to act as a heat sink. Accordingly, portions of the lower structure 200 may be formed of thermally conductive material. Moreover, portions of the lower structure 200 may include fins 214. In this embodiment, the fins 214 are configured to run the length of the lower section 201 and extend radially outward therefrom. The fins 214 increase the surface area of the lower structure 200 and permit fluid flow between each fin 214 thereby enhancing the cooling capability of the lower structure 200. The fins 214 may have a curved vertical profile to emulate the shape of traditional incandescent light bulbs. Optionally, the fins 214 may be configured to conform to the A19 light bulb standard size. Additional information directed to the use of heat sinks for dissipating heat in an illumination apparatus is found in U.S. Pat. No. 7,922,356 titled Illumination Apparatus for Conducting and Dissipating Heat from a Light Source, and U.S. Pat. No. 7,824,075 titled Method and Apparatus for Cooling a Light Bulb, the entire contents of which are incorporated herein by reference.

Furthermore, the lower structure 200 may include interior channels formed in the body member 209. The interior channels may extend from a first opening 216 in an upper surface 222 of the body member 209 to a second opening 218 in an interior surface 224 of the upper section 203 forming the longitudinal cavity 208. Air may be permitted to flow through the interior channels, providing additional cooling capability. Alternatively, the lower structure 200 may be formed as a substantially solid structure, not including the various structural aspects intended to increase the cooling capacity as described above. The lower structure 200 may further include a recessed region 220 formed in the upper surface 222 of the body member 209. The recessed region may extend from the void of the upper section 203 to the outside surface 210.

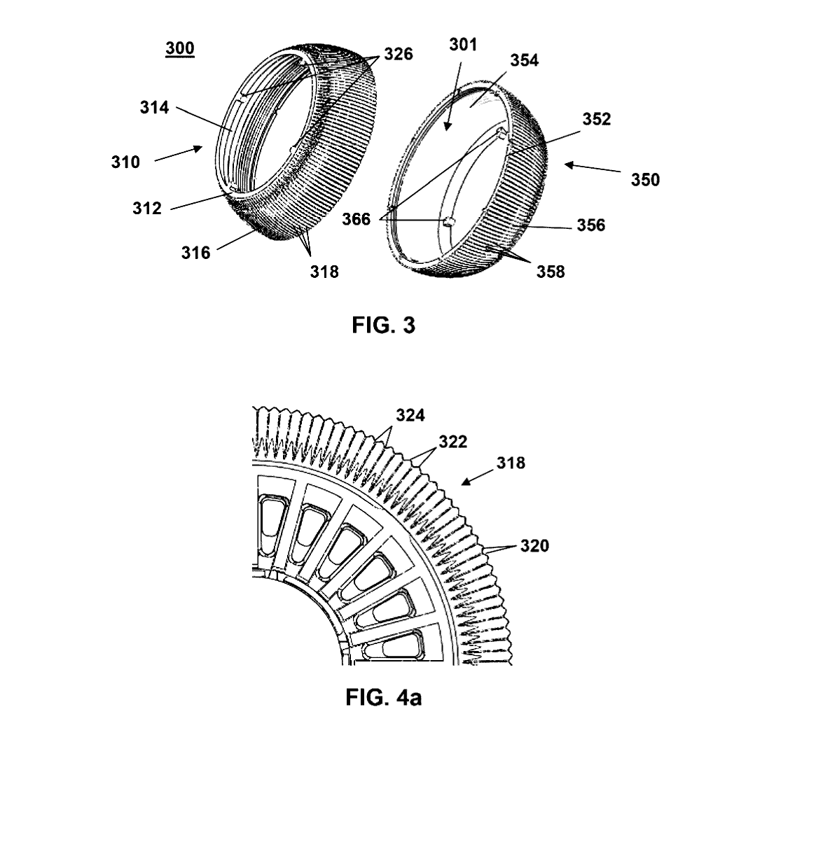

Referring now to FIG. 3, a prismatic optic 300 according to an embodiment of the present invention is depicted. In the embodiment, the prismatic optic 300 may include an upper optic 310 and a lower optic 350. The upper optic 310 may be attached to the lower optic 350 by any method known in the art, including, but not limited to, threaded coupling, interference fit, adhesives, glues, fasteners, and welding, or combinations thereof. Moreover, in an alternative embodiment, the upper optic 310 and the lower optic 350 may be integrally formed as a single optic. The prismatic optic 300 is configured to define an optical chamber 301, wherein the optical chamber 301 is configured to permit a light source to be disposed therein.

The prismatic optic 300 may be formed of any transparent, translucent, or substantially translucent material including, but not limited to, glass, fluorite, and polymers, such as polycarbonate. Types of glass include, without limitation, fused quartz, soda-lime glass, lead glass, flint glass, fluoride glass, aluminosilicates, phosphate glass, borate glass, and chalcogenide glass.

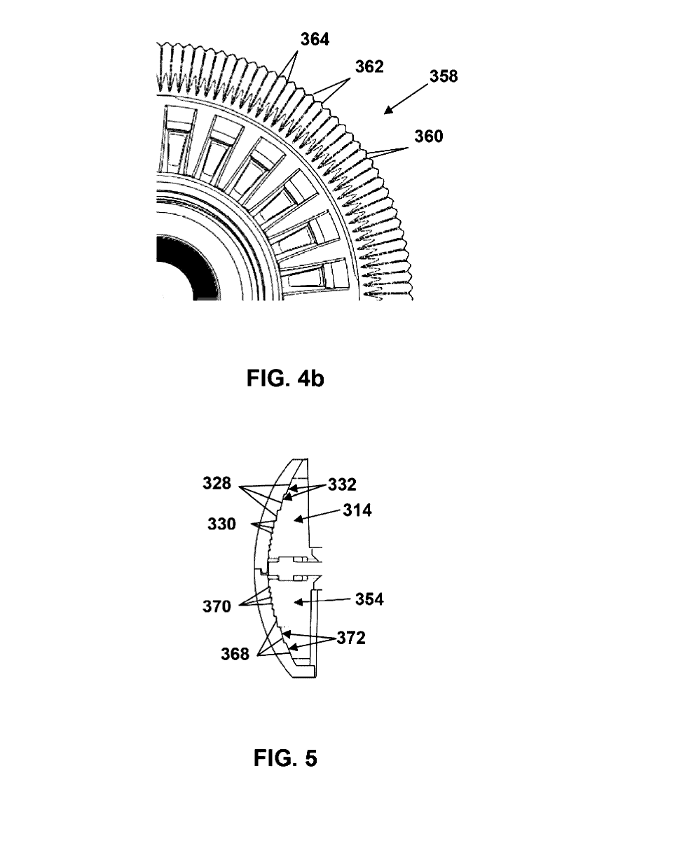

Each of the upper optic 310 and the lower optic 350 may include a sidewall 312, 352 comprising an inner surface 314, 354 and an outer surface 316, 356. Each of the outer surfaces 316, 356 may comprise a plurality of grooves 318, 358 formed thereon. Turning to FIGS. 4 a-b, the grooves 318, 358 are configured to have substantially straight sides 320, 360, the sides forming alternating peaks 322, 362 and valleys 324, 364. The angles formed at the peaks 322, 362 and valleys 324, 364, as well as the length of the sides 320, 360 may be selectively chosen to alter the refraction of light thereby.

Returning now back to FIG. 3, each of the outside surfaces 316, 356 may be configured to have a curvature. The degree of the curvature may be selected according to design standards, such as, a curvature that conforms to an A19 light bulb standard, having a diameter of about 2.375 inches. The curvature may also conform to any other industry standard, including, but not limited to, A15 (about 1.875 inches), A21 (about 2.625 inches), G10 (about 1.25 inches), G20 (about 2.5 inches), G25 (about 3.125 inches), G30 (about 3.75 inches), and G40 (about 5 inches). The preceding is provided for exemplary purposes and is not limiting in any way.

The lower optic 350 may include one or more protruding members 366 extending radially inward from a first end of the inner surface 354. The protruding members 366 may be configured to pass through the one or more channels 212 to interface with the attachment sections 207, which are depicted in FIG. 2. Each protruding member 366 may be associated with one channel 212 and one attachment section 207. Each of the protruding members 366 may be attached to an attachment section 207, thereby attaching the optic 300 to the lower structure 200. The protruding members 366 may be attached to the attachment sections 207 by any method that can withstand the forces experienced by the luminaire 100. Such forces may include those experienced during installation and removal. Methods of attachment include, but are not limited to, adhesives, glues, welding, and fasteners. Similarly, the upper optic 310 may include protruding members 326 extending radially inward from a first end of the inner surface 314. The protruding members 326 may be configured to attach to the upper structure 600 described in detail hereinbelow.

Referring now to FIG. 5, each of the inner surfaces 314, 354 may include a plurality of generally vertical segments 328, 368 and a plurality of generally horizontal segments 330, 370. Each of the generally vertical segment 328, 368 may have two ends and may be attached at each end to a generally horizontal segment 330, 370, thereby forming a plurality of prismatic surfaces 332, 372. It is not a requirement of the invention that the generally vertical segments 328, 368 be perfectly vertical, nor is it a requirement that the generally horizontal segments 330, 370 be perfectly horizontal. Similarly, it is not a requirement of the invention that the generally vertical segments 328, 368 be perpendicular to the generally horizontal segments 330, 370. Each of the prismatic surfaces 332, 372 may be smooth, having a generally low surface tolerance. Moreover, each of the prismatic surfaces 332, 372 may be curved, forming a diameter of the inner surfaces 314, 354.

The variance of the generally vertical segments 328, 368 from vertical may be controlled and configured to desirously refract light. Similarly, the variance of the generally horizontal segments 330, 370 from horizontal may be controlled and configured to produce prismatic surfaces 330, 370 that desirously refract light. Accordingly, the prismatic surfaces 332, 372 may cooperate with the grooves 318, 358, as depicted in FIGS. 3 and 4 a-b, to refract light about the luminaire 100 (shown in FIG. 1).

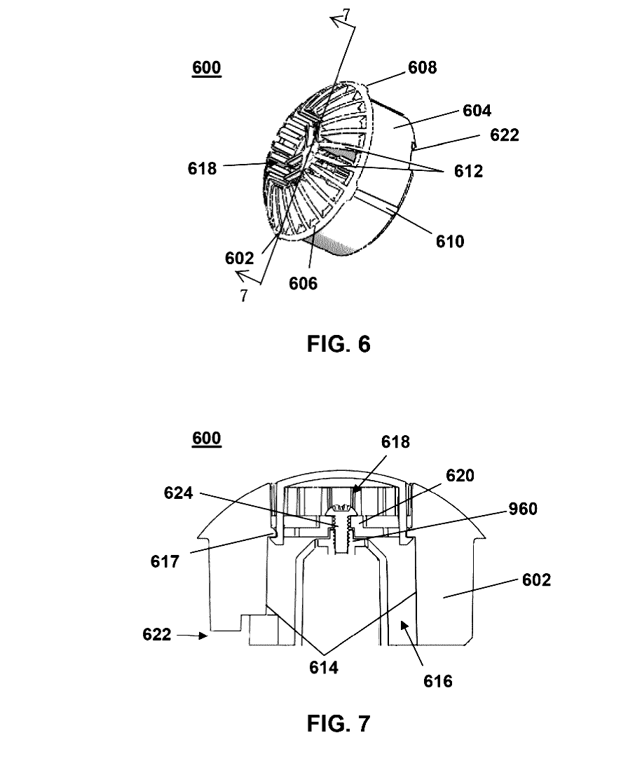

Referring now to FIG. 6, the upper structure 600 of an embodiment of the present invention is depicted. The upper structure 600 may include a body member 602 having an outer surface 604. The outer surface 604 may be configured to reflect light incident thereupon. The outer surface 604 may have a reflection coefficient of at least about 0.1, or about 0.2, 0.3, 0.4, 0.5, 0.6, 0.7, 0.8, or 0.9, or about 0.91, 0.92, 0.93, 0.94, 0.95, 0.96, 0.97, 0.98, or 0.99, or about 1. In one embodiment, the outer surface 604 may act as a substrate and may have a layer of reflective paint applied thereto. In another embodiment, the outer surface 604 may have a reflective liner applied thereto.

The upper structure 600 may further include a ridge 606. The ridge 606 may interface with the prismatic optic 300, thereby constraining the prismatic optic 300 between the upper structure 600 and the lower structure 200. Furthermore, the ridge 606 may include one or more attachment surfaces 608 configured to facilitate attachment of the upper structure 600 to the prismatic optic 300, as shown in FIG. 3. The protruding members 326 of the upper optic 310 may be attached to the attachment sections 608 by any method that can withstand the forces experienced by the luminaire 100, such as those experienced during installation and removal. Methods of attachment include, but are not limited to, adhesives, glues, welding, and fasteners.

The upper structure 600 may further include one or more channels 610 formed in the outer surface 604. The channels 610 may be configured to align with the attachment sections 608, permitting the passage of protruding members 326 therethrough and facilitating the attachment of the prismatic optic 300 to the upper structure 600.

In an embodiment, the upper structure 600 may be configured to act as a heat sink. Accordingly, portions of the upper structure 600 may be formed of thermally conductive material. Moreover, portions of the upper structure 600 may include fins 612. In the illustrated embodiment, the fins 612 are configured to extend from the ridge 606 generally upwards and towards a longitudinal axis of the upper structure 600. The fins 612 advantageously increase the surface area of the upper structure 600 and permit fluid flow between each fin 612, enhancing the cooling capability of the lower structure 600. The fins 612 may have a curved vertical profile to emulate the shape of traditional incandescent light bulbs. Optionally, the fins 612 may be configured to conform to the A19 light bulb standard size. Those skilled in the art will appreciate that the present invention contemplates the use of various configurations of fins to enhance heat dissipation.

Referring now additionally to FIG. 7, the body member 604 may further include an inner surface 614 defining an internal cavity 616. The internal cavity 616 may be configured to cooperate with the longitudinal cavity 208 of the lower structure 200, defining a continuous cavity. Furthermore, the body member 602 may include a shelf 617 extending radially inward from the inner surface 614 into the internal cavity 616.

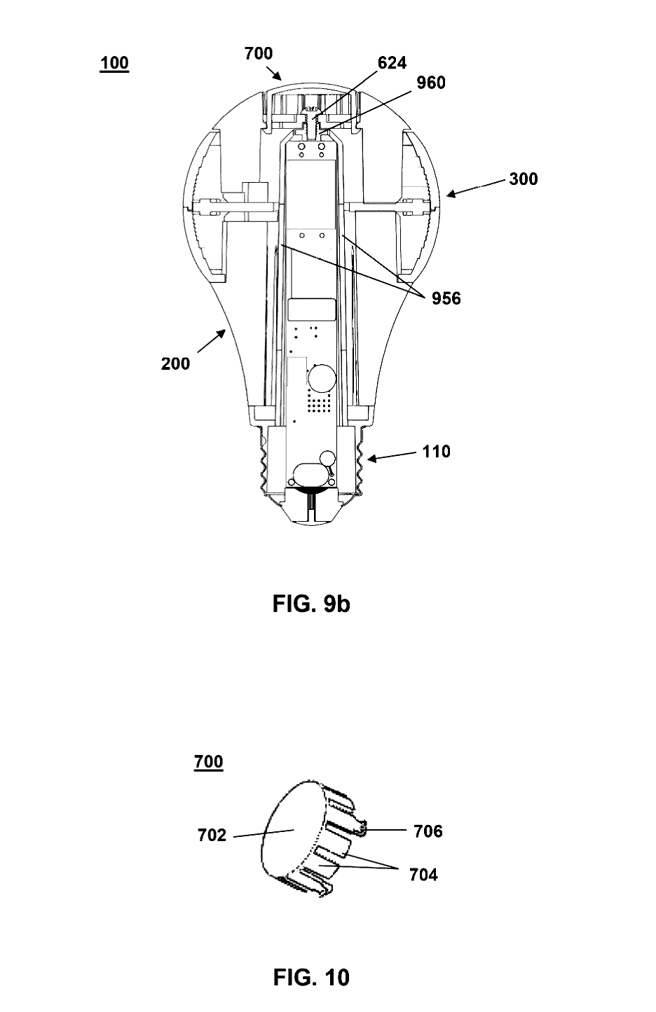

As also illustrated in FIGS. 6-7, the upper structure 600 may further include a recessed section 618 on the top of the upper structure 600. The recessed section 618 may include an upper attachment section 620. The upper attachment section 620 may be configured to attach a housing 900 (described below and illustrated in FIG. 9) thereto. The attachment section 620 may be configured to permit attachment by any method known in the art, including, but not limited to, fasteners, such as screw and threads, adhesives, glues, and welding. The upper structure 600 may further include a recessed region 622 formed in a lower surface of the body member 604. The recessed region 622 may be positioned so as to approximately align with the recessed region 220 of the lower structure 200. Alternatively, the upper structure 600 may be formed as a substantially solid structure, not including the various structural aspects intended to increase the cooling capacity as described above.

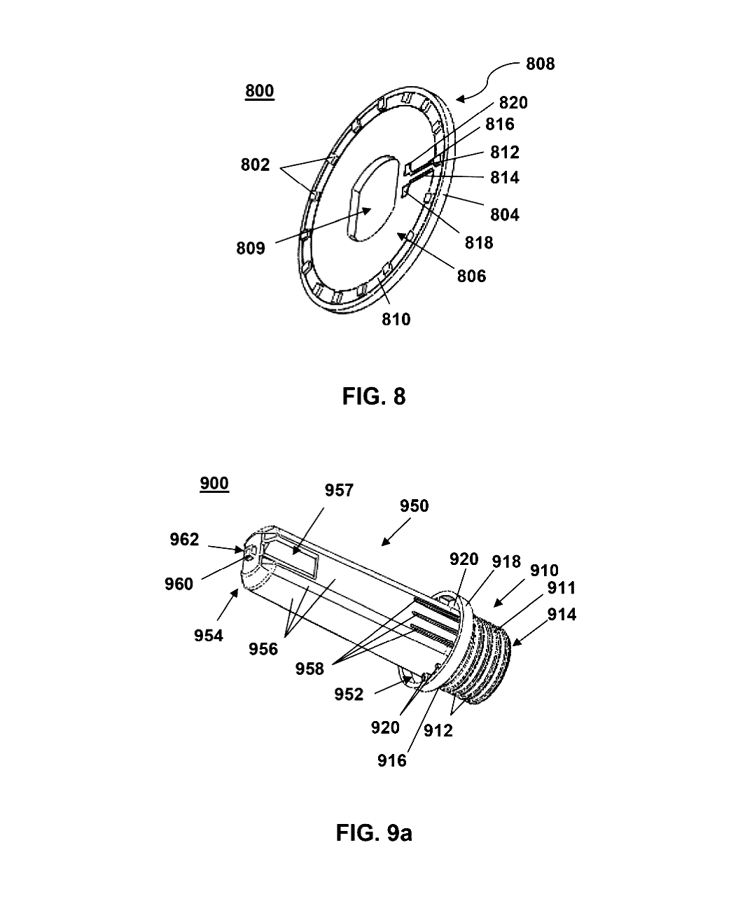

Referring now to FIG. 8, according to an embodiment of the invention, a luminaire including a light source 800 is provided. The present embodiment of the light source 800 employs one or more light emitting elements 802. The light emitting elements 802 may be disposed within the optical chamber 301 of the prismatic optic 300, as depicted in FIG. 3.

The light emitting elements 802 may be oriented to emit light that is incident upon the prismatic surfaces 332 of the upper optic 310 as well as the prismatic surfaces 372 of the lower optic 350 as depicted in FIG. 3. Accordingly, the light emitting elements 802 may be configured to emit light generally radially and outward as well as upwards and downwards from the luminaire 100 as shown in FIG. 1.

According to the present embodiment of the invention, the light source 800 may include a platform 804. The platform 804 may include an upper surface 806, a lower surface 808, and a void 809, wherein each of the upper and lower surfaces 806, 808 are generally flat and configured to permit attachment of the light emitting elements 802 thereto. For example, the light source 800 may include a channel 810 formed into one of the upper surface 806 and the lower surface 808, or both. The channel 810 may be configured to form a region in the upper surface 806 into which the light emitting elements 802 may be attached.

The location of the channel 810 on the upper surface 806 may be selectively chosen. In the present embodiment, the channel 810 is formed generally about the periphery of the upper surface 806, although the channel 810 may be formed in any part of the upper surface 806. In some embodiments, a plurality of light emitting elements 802 may be distributed within the channel 810. Each of the plurality of light emitting elements 802 may be selectively distributed. For example, they may be spaced at regular intervals. In an alternative example, the light emitting elements 802 may be clustered in groups. The configuration of the disposition of the light emitting elements 802 may be selected to achieve a desired lighting profile or outcome.

The channel 810 may further include an attachment material disposed within the channel 810. The attachment material may facilitate the attachment of the light emitting elements 802 within the channel 810. Furthermore, the attachment material may facilitate the operation of the light emitting elements 802. For example, where the light emitting elements 802 are LEDs, the attachment material may be formed of an electrically conductive material. Furthermore, the attachment material may be configured to include two or more electrical conduits that are isolated from each other, facilitating the operation of the light emitting elements 802.

The light source 800 may further comprise a communication section 812 formed adjacent the channel 810. Accordingly, the communication section 812 may be formed in either of the upper surface 806 and the lower surface 808, or both. The communication section 812 may contact the channel 810. Furthermore, the communication section 812 may be formed of an electrically conductive material. Accordingly, the communication section 812 may be in electrically coupled to the channel 810.

The communication section 812 may include a first terminal 814 and a second terminal 816. Each of the first and second terminals 814, 816 may be formed of an electrically conductive material, may contact the channel 810, and further may be electrically coupled to the channel 810. Furthermore, where the channel 810 may include an attachment section including two or more isolated electrical conduits, the first terminal 814 may be in communication with a first electrical conduit of the attachment section, and the second terminal 816 may be in communication with a second electrical conduit of the attachment section. For example, and not by limitation, the first terminal 814 may be in communication with a power source conduit, and the second terminal may be in communication with a ground conduit.

Still referring to FIG. 8, the first and second terminals 814, 816 may each include a pad 818, 820 respectively. The pads 818, 820 may be configured to facilitate attachment of an electrical communication medium thereto. For example, and not by limitation, the dimensions of the pads may be selectively chosen to permit a wire to be soldered thereto. The pads 818, 820 may be disposed approximately adjacent to the void 809. Moreover, the pads 818, 820 may be positioned so as to approximately align with the recessed region 220 of the lower structure 200 and the recessed region 622 of the upper structure 600. The void 809 may be disposed about approximately the center of the platform 804. The void 809 may be positioned and dimensioned to approximately align with the longitudinal cavity 208 as shown in FIG. 1 and the internal cavity 616 as shown in FIG. 7, defining a continuous cavity.

Referring now to FIG. 9 a housing 900 according to an embodiment of the invention is presented. The housing 900 may be configured to be disposed substantially about a power source. The housing 900 may include a base section 910 and a monolithic section 950. The base section 910 may be configured to attach the housing 900 to the base 110 as shown in FIG. 1. Specifically, the base section 910 may include a body member 911 including a plurality of threads 912 configured to cooperate with the threads 114 of the base 110. The threads 114 are functional on both an inside surface and an outside surface of the base 110. Alternatively, the base section 910 may be attached to the base 110 by other methods, including, but not limited to, adhesives, glues, fasteners, and welding.

The base section 910 may include an opening (not shown) at a first end 914. The opening may be configured to have the shape and sufficient dimensions to permit a power source to pass therethrough. The base section 910 may further include a flange 916 extending radially outward from the body member 911. The base section 910 may still further include a sidewall 918 extending approximately orthogonally from the flange 916. In one embodiment, the sidewall 918 may be configured to interfere with the fins 214 of the lower structure 200. In such an embodiment, the housing 900 may be disposed within the longitudinal cavity 208 of the lower structure 200. In this embodiment, the interference between the sidewall 918 and the fins 214 restricts the translation of the housing 900 beyond the point of the interference. Further, the base section 910 may include one or more ribs 920 that may be attached to the sidewall 918, the flange 916, and the monolithic section 950.

The monolithic section 950 may be configured as a hollow, generally straight, substantially elongated structure. It may include a first end 952 and a second end 954, with the first end 952 being adjacent to the base section 910 and the second end 954 being substantially apart from the base section 910. The monolithic section 950 may include one or more sidewalls 956 intermediate the first end 952 and the second end 954, that extend generally upward from the base section 910. The sidewalls 956 may be attached and continuous, so as to define an internal cavity there between. The dimensions of the internal cavity may be sufficient to permit a power source to be at least partially disposed therein, as depicted in FIG. 9 b.

At least one of the sidewalls 956 may include an opening 957 towards the second end 954. The opening 957 may be configured to facilitate the electrical coupling between a power source and the light source illustrated in FIG. 8.

At least one of the sidewalls 956 may include one or more vents 958. The vents 958 may be positioned anywhere along the sidewall 956. In the present embodiment, the vents 958 are positioned substantially toward the first end 952. The positioning of the vents 958, as well as their shape and dimensions, may be selected so as to facilitate the flow of air between the internal cavity defined by the sidewalls 956 and the area surrounding the housing 900. In one embodiment of the invention, the flow of air may increase the cooling capability of the housing 900 thereby reducing the operating temperature of a power source disposed within the internal cavity defined by the sidewalls 956. For example, the vents 958 may be positioned adjacent those parts of a power source that generate the most heat, permitting the rapid transportation of air heated by the power source out of the housing 900. This heat may be transferred to other heat sinks, such as certain embodiments of the upper structure 200 and the lower structure 600.

The monolithic section 950 may further include an attachment section 960 located substantially towards the second end 954. Referring now to FIG. 7, the attachment section 960 may be configured to attach to the upper attachment section 620 of the upper structure 600. The attachment section includes a receiving lumen 962 through which a fastener may be disposed and attached thereto. In the present embodiment, a fastener 624 is disposed through the upper receiving section 620 and into the receiving lumen 962, attaching to the receiving lumen, thereby fixedly attaching the housing 900 to the upper structure 600. However, alternative embodiments permit the attachment section 960 to attach to the upper attachment section 920 by any method known in the art, including, but not limited to, adhesives, glues, and welding.

Referring now to FIG. 10, according to an embodiment of the invention, a luminaire including a cap 700 is provided. The cap 700 is configured to cover the recessed section 618 of the upper structure 600, as depicted in FIG. 7. The cap 700 includes a domed section 702 and a plurality of tabs 704 extending generally downward and approximately perpendicular to the domed section 702. One or more of the plurality of tabs 704 may include a catch 706 disposed on one end of the tab 704. As shown in FIG. 7, the catch 706 may engage with the shelf 617 of the upper structure 600, thereby removably coupling the cap 700 to the upper structure 600.

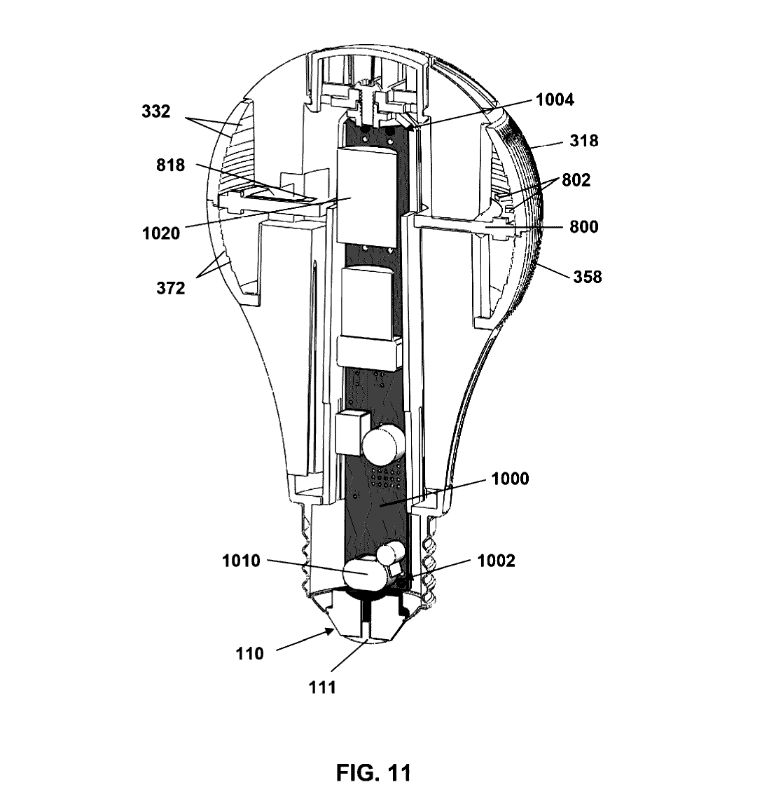

Referring now to FIG. 11, a power source according to an embodiment of the present invention is presented. In the present embodiment, the power source may include a circuit board 1000. The circuit board 1000 may be configured to condition power to be used by the light emitting elements 802 of the light source 800. Furthermore, the circuit board 1000 may have a first end 1002 and a second end 1004, wherein the first end 1002 is positioned generally downward and toward the base 110, and the second end 1004 is positioned generally upward and toward the upper structure 600. The circuit board 1000 may be dimensioned to permit at least a portion of the circuit board 1000 to be disposed within the internal void of the housing 900.

The circuit board 1000 may include a first electrical contact 1010. The first electrical contact may be positioned toward the first end 1002 of the circuit board 1000. The first electrical contact 1010 may be configured to electrically couple with the electrical contact 111 of the base 110, thereby enabling the first electrical contact 1010 to supply power to the circuit board 1000. The circuit board 1000 may further include a second electrical contact 1020. The second electrical contact 1020 may be positioned toward the second end 1004 of the circuit board 1000. The second electrical contact 1020 may be configured to electrically couple with the pads 818, 820 of the light source 800. The electrical coupling between the second electrical contact 1020 and the pads 818, 820 enables the circuit board 1000 to deliver power to the light emitting elements 802.

In an embodiment, the electrical contact 111 conducts power from a light fixture that provides 120-volt alternating current (AC) power. Furthermore, in the embodiment, the light emitting elements 802 comprise LEDs requiring direct current (DC) power at, for instance, five volts. Accordingly, the circuit board 1000 may include circuitry for conditioning the 120-volt AC power to 5-volt DC power.

In a further embodiment, the circuit board 1000 may include a microcontroller. The microcontroller may be programmed to control the delivery of electricity to the light source. The microcontroller may be programmed to, for instance, dim the light emitting elements 802 according to characteristics of the electricity supplied through the electrical contact 111.

Referring now to FIG. 11, the light emitted from the light emitting elements 802 may cooperate with the prismatic surfaces 332, 372 and the grooves 318, 358 to refract the emitted light substantially about the luminaire 100. The prismatic surfaces, 332, 372 and the grooves 318, 358 may be configured to selectively refract light within desired ranges about the luminaire 100. Furthermore, the light may be refracted to maintain a uniform intensity within desired ranges about the luminaire 100.

It is understood that the angles referred to herein are measured according to a polar coordinate system, wherein the angles are measured from the positive Z-axis directed vertically. Moreover, the intensities referred to are in reference to an intensity of the light emitted by the luminaire 100 within a certain angle range. In the present embodiment of the invention, the reference intensity is an average intensity of light emitted within the range of angles between 0 degrees and 135 degrees.

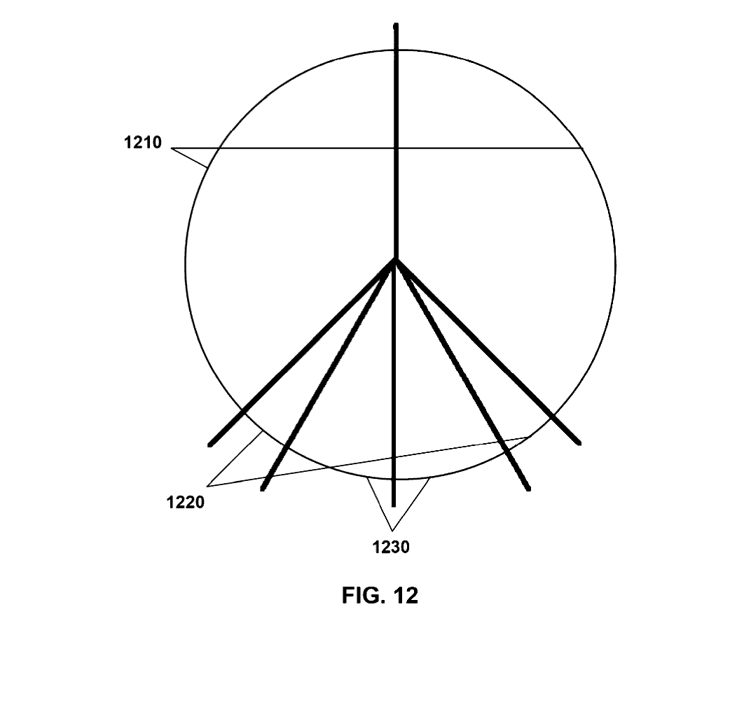

Turning now to FIG. 12, a graph of ranges of light refraction is presented. Light may be refracted within a first range 1210 about the luminaire. The first range 1210 may include angles within a range between about 0 degrees to about 135 degrees. Furthermore, the light emitted within the first range 1210 may be within about 20%, 10%, 5%, or 1% of the average intensity.

Light may also be refracted within a second range 1220 about the luminaire 100. The second range 1220 may include angles within a range between about 135 to about 150 degrees. Furthermore, the light emitted within the second range 1220 may be within about 20%, 10%, 5%, or 1% of the average intensity. Light may also be refracted within a third range 1230 about the luminaire 100. The third range 1230 may include angles within a range between about 150 degrees to about 180 degrees. Furthermore, the light emitted within the third range 1230 may be within about 20%, 10%, 5%, or 1% of the average intensity.

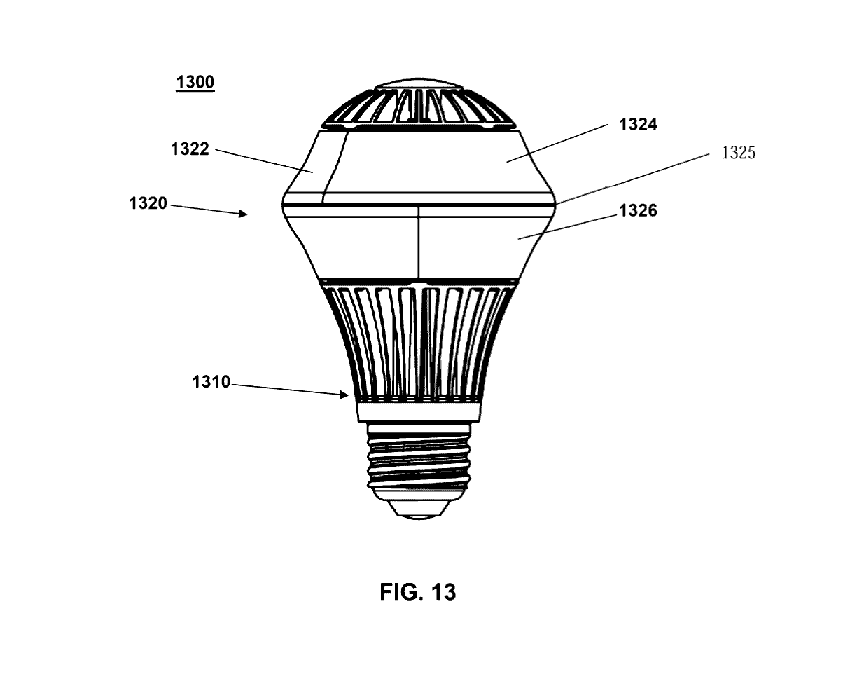

Referring now to FIG. 13, an alternative embodiment of the invention is presented. In FIG. 13, a luminaire 1300 is presented having similar elements to that of the embodiments described hereinabove. Specifically, the luminaire 1300 may include a body member 1310 and an optic 1320 carried by the body member 1310. The optic 1320 may include an optical chamber comprising an upper optic 1324 and a lower optic 1326 that are concave and attach to each other at an equator 1325. The equator 1325 may have a diameter greater than the diameter of the remaining portions of the luminaire 1300. The degree of concavity of both the upper optic 1324 and the lower optic 1326 may be configured to distribute light about the optic 1320 in a desired distribution. The remaining elements of the luminaire 1300 may be substantially as described in the previous embodiments hereinabove.

An embodiment of the invention, as illustrated in FIG. 11, provides a luminaire 1400, having a plurality of lighting elements 802. As additionally illustrated in FIG. 8, these light emitting elements 802 comprise a first plurality located on the upper surface 806 and a second plurality located on the lower surface 808 of the light source 800 thereby emitting light in both an upwards direction and a downwards direction.

The first plurality of light elements 802 disposed on the upper surface 806 and the second plurality of light elements 802 disposed on the lower surface 808 are connected to one or more driver circuits (not shown) which can drive at least some of the first plurality of light elements 802 separately from at least some of the second plurality of light elements 802. In one embodiment, the first plurality of light elements 802 can be driven independently from the second plurality of light elements 802. Alternatively, each light element 802 may be driven separately depending on the functionality and complexity of the circuitry desired. The driver circuits can also be configured to vary the intensity of the lighting elements 802, or sub-sets thereof, by utilizing pulse width modulation.

The control method for the light elements 802 is not particularly limited. In an exemplary embodiment, a sensor 1451 may include an infrared (IR), or some other electromagnetic detecting sensor, which can be used to detect the presence of an object in relation to the luminary. The sensor(s) 1451 can be connected through a connection line 1453 to an internal processor/circuit (not shown) in the circuit board 1000. In some embodiments, the internal processor may be comprised by the light source 800, being positioned on a circuit board associated therewith. The sensor 1451 may determine when an object is present as well as the relative direction of movement, etc.

In an exemplary embodiment, sensor 1451 may include an electromagnetic radiation (EMR) emitter and receiver so that reflected EMR can detect the presence or movement of an object. In addition, sensor 1451 may use only an EMR receiver portion to detect the presence of an object through reflected, ambient or other environmental EMR. This may detect an image or a change in an intensity or pattern of the EMR detected. In some embodiments, the sensor 1451 is included in at least one of the light elements 802. In other words, light elements 802 may include the sensors 1451 as a part thereof. These sensors 1451, in conjunction with the processor 1052, can be used to determine any or all of an objects proximity, location, speed, distance, received light change, etc., depending on the method of control desired.

In some embodiments, the sensors 1451 may include a wireless receiver to detect radio signals, visual light, acoustic signals, etc. as input and can send an output to the driver circuit 1052. Additionally, the luminaire can include a clock which can send an input to the driver circuit 1052 so that the lighting elements 802 are controlled at least partially based on time (e.g., time of day, day of year, etc.).

The output signal of the sensor 1451 is not particularly limited. For instance, the signal can be an analog signal, a digital signal, a triode alternating current signal, an electrical signal received from a three-way lamp socket, or any other appropriate signaling method.

The location of the sensor 1451 is not particularly limited and can be located inside or outside of the optical chamber 301 depending on sensor type and direction desired. In an exemplary embodiment, one or more sensors 1451 are located in the top of upper structure 600 and connected to circuit board 1000 through connecting lines 1453. Furthermore, the number of sensors 1451 is not particular limited. For instance, sensors 1451 can be arranged at the end points of an imaginary square, equidistant from the center of the upper structure 600. Other examples include arranging the sensors 1451 in a circular arrangement, a generally spherical arrangement, a triangular arrangement, etc.

Using the input from sensor 1451, the driver circuits 1454 can drive the downward emitting light elements when a predetermined condition is detected. For example, this may happen when a hand is waved above or below the luminaire 1400 when an object 1480, such as a hand, moves toward or away from the sensor 1451, when an object 1480 moves along a relative upward or downward axis, or when a change in the intensity or pattern of the received EMR changes.

For instance, an exemplary operation may include detection by the sensor 1451 of a reflectance of EMR emitted by the luminaire 1400 (and/or other reflected environmental light) such that the sensor 1451 emits a signal indicating the presence of an object 1480 within a certain proximity of either the lower hemisphere or upper hemisphere of the luminaire.

In another exemplary embodiment, the sensor 1451 can include a sound/vibration detector. The internal processor 1052 can then detect a sound having a certain frequency, pattern, etc. Moreover, the processor 1052 may be configured to process voice commands. Thus, the behavior of the lighting (e.g., direction) can be adjusted by the voice of the user (e.g., word(s) spoken, tone, timing, etc.). In addition, the sound/vibration detector can include a sound emitter so as to detect the presence of an object through active echolocation. The local processor 1052, sensor 1451, and driver circuits 1454 can be interconnected using any acceptable means and can also be connected to each other and/or to the power circuit.

Another method of controlling the luminaire 1400 is through touch. For instance, touch control can be accomplished through the use of one or more of the sensors 1451 which can detect a touch event. The sensor 1451 may include an inductive detection circuit such that, if a user touches the sensor 1451 an input signal may be triggered. Other types of touch or proximity detection circuits such as capacitive, pressure, mechanical switches, etc., are possible to incorporate as a sensor 1451.

In some embodiments, the sensor 1451 may include a matrix or pattern of conductors, such as transparent indium tin oxide (ITO), which may actively or passively detect changes in capacitance from the touch of an object, such as a user's hand. This, or other methods used in digitizer technology can be applied to a portion of the luminaire 1400. Because of the transparent nature of some exemplary capacitive detection technologies like those described, the touch sensitive portion may be located on the optical chamber 300 without substantially interfering with light transmission. In some embodiments, opaque capacitive detectors, or other position detection technologies, can be used.

In some embodiments, the sensor 1451 may include a pressure sensitive detector. The method of pressure detection is not particularly limited and may include pressure switches, a light grid, etc.

As can be seen, the sensor 1451 can include a single type of sensor or may include a combination of different sensors types. These different sensor types can be located together or separately depending on the preference and ease of manufacture.

In some embodiments, the sensor 1451 may operate based on simple contact without position determination. For instance, the sensor 1451 may be tapped or contact held on the sensor to cycle through lighting modes.

In addition, the luminaire 1400 may include a modal input 1454, such as a switch, which can be used in addition to other sensors 1451. The modal input 1454, for example, may be used to turn the lighting elements 802, or a portion thereof, on or off. Furthermore, the modal input 1454 may be used to turn the input sensors 1451, or a portion thereof, on or off. The modal input 1454 may be placed on an external portion of the luminaire 1400 so as to allow operation by a user.

The possibilities for lighting control using the sensor 1451 in conjunction with the driving circuits and plurality of upward and downward directed light elements 802 are varied.

In some embodiments the LEDs themselves may be the sensing devices. In this embodiment a first sensor device, defined as a first LED sensor may be selected from the plurality of LEDs located in the upper hemisphere of the optic and a second sensor device, defined as a second LED sensor, may be selected from the plurality of LEDs located in the lower hemisphere of the optic.

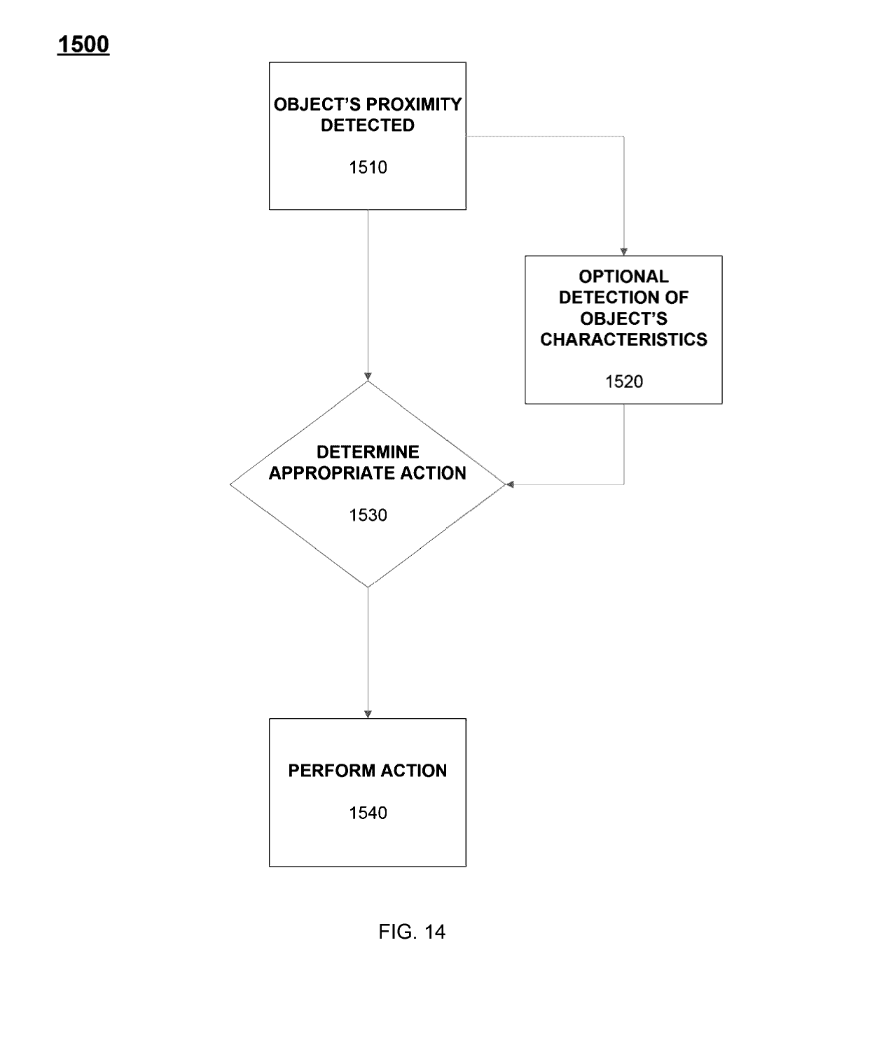

FIG. 14 illustrates an exemplary embodiment of the system. Starting with block 1500, the proximity of an object(s) may be detected from an input from a sensor(s) at block 1510. Optionally, the properties of the object, such as location, relative distance, color, luminosity, etc., can be computed using the input at block 1520. Then, the appropriate action in response to the input from the sensor, given the current operational state of a luminaire, may be determined at block 1530. The luminaire may then carry out the appropriate lighting action at block 1540. The method can end at block 1550

For example, when a first input state is detected, the luminaire can be set to emit light in a generally omnidirectional direction. This can be obtained by activating both upper lighting elements and lower operating elements at a set intensity (e.g., maximum intensity). The method/cycle can end at block 1660.

When a second input state is detected (e.g., an object is detected under the luminaire 1400) the luminaire may emit light in a generally downward direction. This can be accomplished by operating only light elements which emit light in the generally downward direction. Alternatively, light elements, which emit light in a generally upward direction, can emit light at a reduced intensity (e.g., through pulse width modulation) while the light elements which emit light in a generally downward direction can emit light at full intensity.

When a third input scenario is detected, the driver circuit may cause the luminaire to emit light in a generally upward distribution. This can be done by only operating light elements that emit light in a generally upward direction. Alternatively, this effect can be achieved by operating light elements that emit light in a generally upward direction at a first intensity (e.g., maximum intensity) and operating light elements that emit light in a generally downward direction at a second intensity which is lower than the first intensity.

For example, in some embodiments, if the modal switch is disabled, then an even distribution of light is generated (e.g., all lighting elements are activated uniformly). While, if the modal switch is enabled, the luminaire may emit light in response to the input signals as described above.

In some embodiments, the response to the input can be a cycling of modes. For example, when an input may be detected from a sensor 1451, the mode of the luminaire may be switched from uniform lighting to downward lighting. Upon detection of another input the luminaire may cycle to upward lighting. Upon detection of yet another input the luminaire may cycle back to uniform lighting, and so forth.

More complicated control techniques are also possible, such as activating the light elements when an object is detected above the luminaire and then increasing or decreasing the intensity of the light elements as the object moves further away or closer to the luminaire.

Another embodiment allows activating or deactivating the light elements closest to the object detected so as to create a directed or masked light source.

While some of the exemplary embodiments have been described in relationship to an object, the object may be a single object or multiple objects. Indeed, an object detected in proximity to the upper half of the luminaire and an object detected in proximity the lower half of the luminaire may be multiple items and/or a single item extending into multiple detection areas.

These methods of control can also be achieved through sound/voice detection and touch control (e.g., sound volume, pitch, length, voice command, movement along the touch sensor, etc.).

Additional control options include increasing or decreasing the intensity of the upper or lower light elements based when an object is detected in a certain position. For example, if a hand is placed over the luminaire and held there, the intensity of the light elements may increase from the previous intensity of lighting element. This cycle may occur every certain period of time so that the intensity can build the longer the hand is in place. Indeed, the period of time or amount of intensity variation can change the longer the object is present (e.g., to speed up the dimming or brightening).

While the above embodiment has been described in relation to a bulb shape having upward and downward mounted lighting elements, the shape of the luminaire and the mounting scheme of the lighting elements can be changed. For instance, the luminaire can have a cylindrical, spherical, triangular, or other shape. Similarly, the mounting configuration of the lighting elements can be configured to meet the desired geometry of the luminaire or the desired lighting control range and so may be mounted to form a spherical shape, mounted to follow the contours of the outward shape of the bulb, etc.

Furthermore, it is possible to utilize multiple control techniques in concert. For example, a user could say “brighten” and the sensed location of an object can increase or decrease brightness (e.g., based on time detected or movement) or a user could say “direction” and the direction of lighting (or intensity in a given direction) can change based on object detection or movement.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A luminaire for directional emission of light comprising:
an optic defining an optical chamber;
a first plurality of light emitting elements located on the upper light source surface;
a second plurality of light emitting elements located on the lower light source surface; and
a driver circuit operably coupled to each of the first and second pluralities of light elements;
wherein the driver circuit is adapted to receive an input;
wherein the driver circuit is configured to operate the first and second pluralities of light elements so as to cause the luminaire to emit light in a downward distribution responsive to the input having a first configuration; and
wherein the driver circuit is configured to operate the first and second pluralities of light elements so as to cause the luminaire to emit light in an omnidirectional distribution responsive to the input having a second configuration.

2. The luminaire according to claim 1 wherein the driver circuit is configured to operate only the second plurality of light elements responsive to the input having the first configuration.

3. The luminaire according to claim 1 wherein the driver circuit is configured to operate the second plurality of light elements at a maximum intensity and the first plurality of light elements at a reduced intensity responsive to the input having the first configuration.

4. The luminaire according to claim 3 wherein the driver circuit is configured to operate the first and second pluralities of light elements at a reduced intensity using pulse width modulation.

5. The luminaire according to claim 1 wherein the driver circuit is configured to operate both the first and the second pluralities of light elements at a maximum intensity responsive to the input having the second configuration.

6. The luminaire according to claim 1 wherein the driver circuit is configured to operate at least one of the first and second pluralities of light elements so as to cause the luminaire to emit light in an upward distribution responsive to an input having a third configuration.

7. The luminaire according to claim 6 wherein the driver circuit is configured to operate only the first plurality of light elements responsive to the input having the third configuration.

8. The luminaire according to claim 6 wherein the driver circuit is configured to operate the first plurality of light elements at a maximum intensity and the second plurality of light elements at a reduced intensity responsive to the input having the third configuration.

9. The luminaire according to claim 6 further comprising a sensor positioned in electrical communication with the driver circuit and configured to determine a reflectance of light emitted by the luminaire; wherein the sensor is configured to generate a signal indicating a presence of an external structure within a proximity of either of a lower hemisphere or an upper hemisphere of the luminaire, the signal generated by the sensor being the input.

10. The luminaire according to claim 9 wherein the sensor comprises a first sensor device and a second sensor device; wherein each of the first and second pluralities of light elements comprises a light-emitting diode (LED); wherein the first sensing device is the LED of the first plurality of light elements; and wherein the second sensing device is the LED of the second plurality of light elements.

11. The luminaire according to claim 1 further comprising a wireless communication device positioned in electrical communication with the driver circuit; wherein the wireless communication device is configured to receive the input, defined as a received input; and wherein the wireless communication device is configured to transmit the received input to the driver circuit.

12. The luminaire according to claim 1 further comprising a user input device positioned in electrical communication with the driver circuit; wherein the user input device generates the input received by the driver circuit; and wherein the user input device is operable to generate at least one of the first and second configurations of the input.

13. The luminaire according to claim 1 further comprising a modal input positioned in electrical communication with the driver circuit and configured to generate a modal input signal comprising one of an enabling signal or a disabling signal; wherein the driver circuit is configured to operate the first and second pluralities of light elements so as to cause the light to be emitted in a downward distribution responsive to the input having the first configuration and the modal input having the enabling signal; and wherein the driver circuit is configured to operate the first and second pluralities of light elements so as to cause light to be emitted in an omnidirectional distribution responsive to the input having the first configuration and the modal input having the disabling signal.

14. The luminaire according to claim 13 wherein the modal input is a switch positioned so as to be manipulable by a user.

15. The luminaire according to claim 1 further comprising a light source board having an upper surface and a lower surface; wherein the first plurality of light elements is positioned on the upper surface of the light source board; and wherein the second plurality of light elements are positioned on the lower surface of the light source board.

16. The luminaire according to claim 1 further comprising a sensor positioned in electrical communication with the driver circuit and configured to determine a reflectance of light; wherein the sensor is configured to generate a signal indicating presence of an external structure within a proximity of the luminaire; and wherein the driver circuit is configured to operate the first and second pluralities of light elements responsive to the signal generated by the sensor.

17. The luminaire according to claim 16 wherein the driver circuit is configured to emit light in an alternating succession of downward and uniform distributions responsive to each signal indicating the presence of the external structure within the proximity of the luminaire generated by the sensor; wherein the driver circuit is configured to alter the distribution from downward to uniform, or vice versa, upon receiving each signal indicating the presence of the external structure.

18. The luminaire according to claim 16 wherein at least one of the first and second pluralities of light elements comprises an LED; and wherein the sensor is the LED.

19. A luminaire for the directional emission of light comprising:
an optic defining an optical chamber;
a first plurality of light elements positioned so as to emit light in a upwards direction;
a second plurality of light elements positioned so as to emit light in a downwards direction;
a driver circuit operably coupled to each of the first and second pluralities of light elements; and
a modal input positioned in electrical communication with driver circuit and configured to generate a modal input signal comprising one of an enabling signal and a disabling signal;
wherein the driver circuit is configured to operate the first and second pluralities of light elements so as to cause light to be emitted in a uniform distribution responsive to an input having a second configuration;
wherein the driver circuit is configured to operate the first and second pluralities of light elements so as to cause light to be emitted in a downward distribution responsive to the input having a first configuration and the modal input having an enabling signal;
wherein the driver circuit is configured to operate the first and second pluralities of light elements so as to cause the luminaire to emit light in a upward distribution responsive to the input having a third configuration and the modal input having the enabling signal; and
wherein the driver circuit is configured to operate the first and second pluralities of light elements so as to cause light to be emitted in an omnidirectional distribution responsive to the input having either of the first or third configurations and the modal input having the disabling signal.

20. A luminaire for the directional emission of light comprising:
an optic defining an optical chamber;
a first plurality of light elements positioned so as to emit light in an upwards direction;
a second plurality of light elements positioned so as to emit light in a downwards direction;
a driver circuit operably coupled to each of the first and second pluralities of light elements;
a first sensing device positioned in electrical communication with the driver circuit and being configured to determine a reflectance of light indicating a presence of an external structure within a proximity of an upper hemisphere of the luminaire and to generate a signal indicating the presence of the external structure within the proximity of the upper hemisphere of the luminaire;
a second sensing device positioned in electrical communication with the driver circuit and configured to determine a reflectance of light indicating the presence of an external structure within the proximity of a lower hemisphere of the luminaire and to generate a signal indicating the presence of the external structure within the proximity of the lower hemisphere of the luminaire; and
wherein the driver circuit is configured to operate the first plurality of light elements responsive to the signal received from the first sensing device; and
wherein the driver circuit is configured to operate the second plurality of light elements responsive to the signal received from the second sensing device.
